(19) United States
(12) Patent Application Publication
(10) Pub. No.: US 2026/0045424 A1
(43) Pub. Date: Feb. 12, 2026

(54) MEMS SWITCH WITH MULTIPLE DEFORMATIONS AND SWITCH COMPRISING ONE OR MORE MEMS SWITCHES

(71) Applicants: AIRMEMS, 87000 (FR); UNIVERSITE DE LIMOGES, Limoges (FR); CENTRE NATIONAL DE LA RECHERCHE SCIENTIFIQUE (CNRS), PARIS CEDEX 16 (FR)

(72) Inventors: Romain STEFANINI, Limoges (FR); Pierre BLONDY, Limoges (FR)

(21) Appl. No.: 19/101,934

(22) PCT Filed: Aug. 4, 2023
(86) PCT No.: PCT/IB2023/057909

§ 371 Date: Feb. 7, 2025

(30) Foreign Application Priority Data
Aug. 8, 2022 (FR) FR2208173

(51) Int. Cl. H01H 1/00

(52) U.S. Cl. CPC H01H 1/0036

(57) ABSTRACT

A MEMS switch, comprising a substrate, at least one signal input line, at least one signal output line, at least one contact zone formed on a contact zone base integral with the substrate, and a contact membrane held by at least one anchoring base integral with the substrate, wherein for each contact zone, the contact membrane constitutes a first entity, the contact base constitutes a second entity and the at least one anchoring base constitutes a third entity, and at least two entities from among the first entity, the second entity and the third entity are deformable, each by an independent actuating means, in order to move the contact membrane towards or away from the contact zone.

The present invention relates to the field of micro-electromechanical systems, referred to by the acronym MEMS, and more particularly relates to a MEMS switch having at least two deformable elements and to a switch comprising one or a plurality of MEMS switches according to the invention.

The MEMS switch according to the present invention may be any type of switch making it possible, depending on the state thereof, to block or convey an electrical or electronic signal, whatever the waveform, the frequency, the power level thereof. This can be e.g. without limitations:
an electrical switch (also called a latching switch or electrical contactor) allowing the routing of direct (DC) or alternating (AC) signals from an electrical apparatus or network (12V-5000 V, 1-200 A, DC-50 Hz);
a circuit-breaker for cutting off the power supply to an installation at the of an overload or of an electrical short-circuit;
an electronic switch for the control of low power digital signals (5 V, 0.5 A);
an ohmic or capacitive radio frequency (RF) switch allowing switching operations to be performed on an impedance of 50 Ohms or 75 Ohms on signals up to 200 GHz.

Current electrical or radiofrequency systems are evolving toward more energy-efficient, more complex and denser architectures. Thereby, the components performing essential electronic functions such as switches are multiplied and must satisfy new constraints:
cost (size, material, manufacturing processes, etc.);
performance (power handling, operating frequency, energy consumption, etc.);
reliability (number of switchings, temperature handling, vibration handling, etc.).

MEMS switch technology naturally has interesting advantages to meet the demand, namely galvanic isolation, purely metallic contact and a sufficiently small size to be able to be produced in big quantities at a lower cost.

The structure of a MEMS switch generally comprises a (entirely or partly metallic or semi-conductor) deformable element made suspended opposite a (entirely or partly insulating or semi-conductor) substrate and secured to the substrate by means of at least one anchor. Same may be e.g. a beam (a cantilever beam or more simply beam or sometimes shortened to cantilever) or a membrane, which must be able to be deformable between two states: a first state wherein an electrical contact is made by the deformable element between a signal input line and a signal output line of the MEMS switch, and a second state wherein an electrical isolation is achieved by the deformable element between the signal input line and the signal output line of the MEMS switch.

An ideal MEMS switch must guarantee both infinite electrical isolation in the open state and provide perfect electrical contact in the closed state. To get closer to the ideal MEMS, engineers have to either compromise on performance or design larger membranes and use specific materials that have a direct impact on manufacturing costs.

Documents FR3090615B1, WO9963562A1, EP1535296A1, EP1535297A1, WO200778589A1, EP1840924A2, EP1850360A1, EP3378087A1, US20200102213A1, U.S. Pat. No. 6,701,779B2 describe the prior art in the field.

The Applicants have thus sought to solve the problem, by proposing a MEMS switch making it possible to enhance the force on the electrical contact in the closed state and/or to increase the electrical: isolation in the open state, by bringing in at least two additional deformable elements secured to the substrate, in particular formed in the substrate or on the substrate used for manufacturing the MEMS switch.

The subject matter of the present invention is thus a micro-electromechanical systems (MEMS) switch comprising:
a substrate,
at least one signal input line,
at least one signal output line,
at least one contact zone formed on a contact zone base secured to the substrate, each contact zone being electrically connected to the at least one input line or the at least one output line,
a contact membrane held facing each contact zone by one amongst an anchoring formed on an anchoring base secured to the substrate and a plurality of anchorings formed on at least one anchoring base secured to the substrate,
the MEMS switch being configured to open or close an electrical path between the at least one input line and the at least one output line through at least one contact zone,
the switch being in the closed position when an electric current flows from at least one input line to at least one output line by contact of the contact membrane on at least one contact zone and in the open position when all the input lines are electrically isolated from all the output lines by an absence of contact of the contact membrane with all the contact zones,
characterized in that for each contact zone, the contact membrane forming a first entity, the contact base forming a second entity and the at least one anchoring base forming a third entity, at least two entities amongst the first entity, the second entity and the third entity are deformable, each by independent means of actuation, to move the contact membrane closer to or further away from the contact zone, to move the contact membrane from an initial open position to a closed position or from an initial closed position to an open position and to enhance at least one of the isolation in the open position and the contact force in the closed position.

The contact membrane is thus at least partially conductive so to make it possible to form an electrical path between the at least one input line and the at least one output line when the contact membrane is in the closed position.

The anchoring base is defined as the surface of a material on which an anchoring or a plurality of anchorings rest to support same, the anchoring base being either deformable or non-deformable. Where the anchoring base is not deformable, it may in particular, but not exclusively, consist of the surface of the substrate situated under the anchoring in question or of a surface secured to the substrate.

The contact zone base is defined as the surface of a material on which the contact zone rests to support same, the contact zone base being either deformable or non-deformable. When the contact zone base is not deformable, it may in particular, but not exclusively, consist of the surface of the substrate situated under the contact zone in question or of a surface secured to the substrate.

Thereby, for each contact zone of a MEMS switch according to the invention, at least two entities among the contact membrane, the contact zone base and the at least one anchoring base are deformable. Within the same switch having a plurality of contact zones, each contact zone may have different deformable elements, depending on the contemplated application.

The means of actuation of each deformable entity are physically independent but can be electrically connected to each other when same serve to improve together a state of the switch and have the same electrical control signal. The means of actuation may be of an electrostatic and/or thermal and/or piezoelectric and/or magnetic nature.

For the above reason, when the prior art shown in Figures A1 and A2 has a MEMS switch 1 formed on a substrate 2 with a MEMS beam 5, which extends a signal input line 3, and a signal output line 4, the contact of the MEMS beam 5 with the signal output line 4 being closed by electrostatic actuation by an electrode (not shown), and the gap at rest between the MEMS beam 5 and the signal output line 4 being g0, the contact force Fc is defined by:

$$Fc = a \cdot Fe - k \cdot Δ x ,$$

with a being a weighting coefficient related to the design of the electrode, Fe is the electrostatic force generated on the MEMS beam 1 by the electrode, k is the stiffness constant of the MEMS beam 5 and Δx=g0 is the travel made by the contact between the open state and the closed state.

Within framework of the invention, the general principle of which is shown in Figures B1 and B2, the elements identical to the elements of Figures A1 and A2 bearing the same reference number, an anchoring base 6a placed under the anchoring 5c of a MEMS beam 5 strictly identical to same described in connection with Figures A1 and A2 can reduce the travel between the contact membrane 5 and the signal output line 4 at Δx=0 and allow the contact force to fully benefit from the electrostatic force in such a way that:

$$Fc = a \cdot Fe$$

The consequence of such an advantage is a reduction in the contact resistance and thus an improvement of handling of the switch to the passing current.

Similarly, when the prior art has a MEMS beam the contact of which is opened by a gap “g0” comprised between 0.1 and 5 μm, the dielectric resistance Vb of the switch can be approximated (see e.g. “The Transition to Paschen's Law for Microscale Gas Breakdown at Subatmospheric Pressure”, Loveless, A. M., Meng, G., Ying, Q. et al., Sci Rep 9, 5669 (2019)) by:

$$Vb ∼ 375 + 25 \cdot g 0$$

with Vb the breakdown voltage in Volts and g0 the initial gap in μm.

Within the framework of the invention, a contact zone base 6b placed under the contact zone of a MEMS beam 5 with the output line 4 can enhance the distance between the contacts by providing an additional space Ag between the contact membrane 5 and the signal output line 4 when the contact zone base 6b is deformed as in Figure B1 so that:

Vb˜375+25. (g0+Δg), resulting in improved dielectric resistance.

Thereby, the invention makes it possible to design MEMS switches that are more efficient with dimensions equal to the dimensions of the prior art, or as efficient with reduced dimensions.

The switch of the present invention may be normally open or normally closed.

In the present invention, the contact membrane generally makes, in the closed position thereof, the electrical connection between the at least one input line and the at least one output line in at least one contact zone and serves to convey an electrical, electronic or radiofrequency signal on an electrical path thereby created by the contact membrane between the at least one input line and the at least one output line. In the particular case of an RF switch, it is also possible for the contact membrane to touch a dielectric contact zone and form a MIM (Metal Insulator Metal) capacitance with the output line to allow RF signals to flow better from the input to the output.

A deformable contact membrane means a membrane designed to be able to flex during an electrostatic, thermal, piezoelectric or magnetic actuation.

The contact membrane can take any shape: straight line, broken line (angle formed between the inlet side and the outlet side of the contact membrane), have more than two branches, etc., and can have one or a plurality of dimples. The contact membrane may also consist of a plurality of layers of materials, at least one of which is conductive. The membrane can also integrate a waveguide between the at least one input line and the at least one output line, as described in European patent application EP 3465724, incorporated by reference into the present application.

Advantageously, the means of actuation of the contact membrane makes it possible to exert additional pressure on the contact zone, the deformation of the anchoring base when same is deformable making it possible to close the contact without creating any bending on the contact membrane (Figure B2).

Thereby, the invention also makes it possible to limit the mechanical forces on the contact membrane, which can therefore be made from conventional, cheaper electrically conductive materials (Al, Cu, AlCu).

Still in the present invention, the anchoring bases and the contact zone bases make it possible, when same are deformable, to move away or toward each other until a contact is brought about between the contact membrane and the at least one facing contact zone.

The anchoring or contact zone base is secured to the substrate. Same can be located:
directly on the surface of the base substrate (Bulk),
on the surface of a layer or set of layers of material covering the base substrate, or
on the surface of a layer or set of layers of material anchored to the substrate and suspended opposite the base substrate.

Deformable base refers to the surface of a layer of material secured to the substrate, apt to be deformed (e.g. a membrane) by an existing electrostatic, thermal, piezoelectric or magnetic means of actuation.

A non-deformable base means the surface of a layer of material designed to remain immobile and not having its own means of actuation.

A switch may consist of a plurality of deformable anchoring bases and/or a plurality of deformable contact zone bases for the same contact membrane, provided that the deformation of the bases makes it possible to move the contact membrane away from or toward at least one facing contact zone.

The deformable anchoring base or deformable contact zone can be on the surface of a membrane secured to the substrate and can take any shape (rectangular, circular, etc.).

When the anchoring or contact zone base is deformable, same may be located on the surface of a membrane covering a cavity defined on the surface or within the base substrate (Bulk).

The anchoring or contact zone base is advantageously made of a thermally and mechanically stable material, which is insensitive to creep and fatigue. The base is not necessarily a good conductor.

For example, for a substrate with a silicon-on-insulator (SOI) structure, the anchoring or contact zone base when same is deformable, is formed on the surface of a thin layer of silicon suspended above a cavity defined within the insulator, the silicon base (Bulk) forming the bottom of the cavity. In such configuration, a difference of potential between the bottom of the cavity and the base creates an electrostatic force which deforms the base. The thin silicon layer is advantageously monocrystalline silicon known for the temperature stability and the mechanical robustness thereof.

In other configurations, when the anchoring or contact zone base is deformable, same consists of an insulating layer, electrodes may be formed on the lower surface of the base, opposite the bottom of the cavity, to form, as in the previous case, a difference of potential between the electrodes and the bottom of the cavity serving to bend the base by electrostatic actuation.

In both cases, the electrostatic means of actuation, the base or electrodes formed on the underside of the base, is parallel to the surface forming the bottom of the cavity.

The fact that the cavity is hermetically closed makes it possible to fill same with gas or to create a vacuum, to make the actuation of the bases more robust, especially against breakdown phenomena.

The surface of each deformable base is advantageously parallel to the surface of the contact membrane, for a simpler manufacture.

Thereby, compared with the prior art indicated hereinabove, the MEMS switch of the present invention provides at least one of the following advantages:
the possibility of using common materials without any degradation of reliability and performance,
greater contact force when the switch is closed,
greater isolation distance between contacts when the switch is open.

Due to the greater contact force in the closed state, the MEMS switch according to the present invention is able to carry more electric current than a MEMS switch according to the prior art.

Moreover, due the greater isolation capacity in the fully open state, the MEMS switch according to the present invention is able to isolate more electrical voltage than a MEMS switch according to the prior art.

Due to the ability thereof to integrate conventional materials, the MEMS switch of the present invention is potentially cheaper to manufacture than prior art MEMS switches having the same performance.

According to one embodiment, the contact membrane is connected to one of the at least one input line and the at least one output line. Thereby, contact is made only between the contact membrane and the at least one of the at least one input line and the at least one output line to which the contact membrane is not connected. The contact is made at the contact zone. The line may be made, without limitations, of gold, copper, aluminum or a conductive alloy. The contact zone may be on the corresponding input or output line, thus like same made of copper, gold, aluminum or a conductive alloy, or preferably but without limitations, be made distinct from the corresponding input or output line but formed on the latter, the contact zone then being made of ruthenium, tungsten or platinum. When the substrate is semiconductive, the input and output lines can be isolated from the substrate by a dielectric layer, e.g. such an oxide (SiO₂) or a nitride (SiN, AlN).

In one embodiment, the contact membrane is isolated from the at least one input line and the at least one output line in the open, preferably fully open position. Thereby, the contact membrane must come into contact with both the at least one input line and the at least one output line in order to obtain an electrical connection in the closed position, at least one contact membrane/input line contact zone and at least one contact membrane/output line contact zone.

In one embodiment, the at least one input line and the at least one output line are formed on the substrate.

According to one embodiment, the at least one input line and the at least one output line are formed parallel to the substrate, on one of a secondary substrate bonded opposite the substrate and an anchoring secured to the substrate. The secondary substrate may be insulating or semiconductive. Bonding is by wafer bonding and can be carried out without limitations by anodic, eutectic, direct, or sintered glass bonding.

According to one embodiment, each deformable base, whether same is an anchoring base or a contact zone base, consists of a cavity membrane at least partially covering a hole formed in the substrate so as to form a cavity at least partially covered by the base. The base can thereby cover all or part of the cavity.

According to one embodiment, the substrate is of the silicon-on-insulator type, the cavity membrane being made of silicon, the cavity being formed between a first silicon layer formed by the substrate and a second silicon layer formed by the cavity membrane, the means for actuation of the cavity membrane being configured to apply a difference of potential between the substrate and the cavity membrane for an electrostatic actuation of the cavity membrane, the applied difference of potential deforming the cavity membrane.

Without limitations, other types of substrates can incorporate cavities and be used within the framework of the present invention:
POI (Piezo On Insulator), which requires electrodes on the piezoelectric material and a device for applying voltage to the electrodes as a means of actuation,
GeOI (Germanium on Insulator), the means of actuation being still a device for applying a difference of potential,
GOI (GaAs On Insulator), the means of actuation being still a device for applying a difference of potential,
SOG (Silicon on Glass), which requires electrodes on the glass (the base of the substrate being insulating), the means of actuation still being a device for applying a difference of potential.

Electrostatic actuation has the advantage of being compact, consuming little energy, being fast and of having good temperature stability compared to other means of actuation (thermal, magnetic, piezoelectric, etc.). For example, see Review of Actuation and Sensing Mechanisms in MEMS-Based Sensor Devices, Algamili, A. S., Khir, M. H. M., Dennis, J. O. et al., Nanoscale Res Lett 16, 16 (2021).

According to one embodiment, each base consists of a cavity membrane supported by cavity membrane anchorings secured to the substrate so as to be suspended facing the substrate and to form an at least partially closed cavity between the substrate, the cavity membrane and the anchorings thereof, the means of actuation of the cavity membrane being configured to apply a difference of potential between the cavity membrane and the surface of the substrate for electrostatic actuation of the cavity membrane, the applied difference of potential deforming the cavity membrane. The cavity membrane can be made without limitations of dielectric (SiN, SiO2, Ta2O5), metal, semiconductor or a set of layers of materials, as long as electrostatic actuation is made possible.

According to one embodiment, the means of actuation of the contact membrane is configured to apply a difference of potential between the contact membrane and the surface below the contact membrane for electrostatic actuation of the contact membrane, the applied difference of potential deforming the contact membrane.

According to one embodiment, the means of actuation the contact membrane is electrostatic and is implemented by an electrode arranged opposite the contact membrane. The electrode may be made, without limitation, of a semiconductor, a metal or of a resistive material.

Thereby, when the base is deformable, whether same is an anchoring base or a contact zone base, a tension applied between the base and the substrate creates an attractive force between the base and the substrate which flexes the base, dragging therewith the anchoring of the contact membrane for an anchoring base or the contact zone for a contact zone base, and an additional attractive force is furthermore created between the contact membrane and the upper surface of the base, so as to provide an optimum and maximum contact of the contact membrane on the at least one input line and/or the at least one output line.

For an equivalent membrane size, the present invention relies on a larger electrostatic actuation surface than a prior art MEMS switch, which induces a greater contact force and a lower resistance (Ron) when the contact membrane contacts the at least one input line and/or the at least one output line, whereby the electrostatic actuation can be carried out both by the contact membrane and by one or a plurality of bases.

However, other means of actuation are also envisaged within the framework of the present invention, which is not limited in this respect: actuation by displacement of the contact membrane by piezoelectric effect, by thermal means, by magnetic means. Such actuation alternatives are well known to a person skilled in the art.

According to one embodiment, the contact membrane is encapsulated in a preferably hermetically sealed encapsulation space formed by one amongst wafer bonding and a thin film. The substrate used for wafer bonding encapsulation may be, but is not limited to, semiconductive (silicon) or insulating (glass). Wafer bonding can be performed by anodic, eutectic, direct, or sintered glass bonding. Thin film encapsulation can in particular, but not exclusively, be carried out by an oxide (SiO2) or a nitride (SiN).

In one embodiment, the encapsulation space of the contact membrane contains one amongst a gas and a vacuum. The gas may consist in particular, but not exclusively, of argon, nitrogen, oxygen, SF6, or mixtures thereof, at different pressure levels.

In one embodiment, each cavity is closed, preferably hermetically, and contains one amongst a gas and a vacuum. The gas may consist in particular, but not exclusively, of argon, nitrogen, oxygen, SF6, or mixtures thereof, at different pressure levels.

According to one embodiment, each anchoring of the contact membrane is formed on or in the vicinity of the maximum bending point of the anchoring base when the anchoring base is deformable and each contact zone is formed on or near the maximum bending point of the contact zone base when the contact zone base is deformable. A maximum deformation in the deformed base position is thereby obtained. However, the anchorings and contact zones may also be at other points of the associated base, provided that the maximum deformation position at said point allows to get significantly closer or further apart, in particular of at least one tenth of the initial distance (gap) separating the contact zone and the contact membrane.

According to one embodiment, the means of actuation the contact membrane is formed under the contact membrane on the surface of the substrate on the base or outside the base. When the means of actuation of the contact membrane is formed outside the base, the contact membrane keeps the parallelism thereof with the electrode in the event of bending of the base during the movement thereof toward the contact zone, with or without bending of the contact membrane by actuation of the latter, allowing a greater contact force to be obtained in the closed state.

It should be noted that, according to the present invention, it is also possible to envisage a contact membrane coming into contact with a plurality of input lines and/or a plurality of output lines defining a plurality of electrical paths between the input and the output of the MEMS switch, located at different height levels in the travel of the contact membrane between the closed position and the fully open position thereof, the different positions of the contact membrane between the two extreme positions thereof being used to activate all or part of the electrical paths depending upon the position of the membrane.

A further subject matter of the present invention is a switch, characterized in that same comprises one or a plurality of MEMS switches as described hereinabove, arranged with one another in a configuration among in parallel, in series and both in parallel and in series. A switch formed from a plurality of elementary MEMS switches as described hereinabove is thereby formed, making it possible to distribute the currents over a plurality of elementary switches to obtain a switch that withstands a higher current, but also to distribute the voltages over the switches arranged in series in order to improve the dielectric strength of the component.

In one embodiment, the switch further comprises a control circuit integrated into the substrate, preferably in the form of an application specific integrated circuit (ASIC). The control circuit thereby makes it possible to control, for each elementary switch, the at least two means of actuation, and can have other functions, such as e.g., without the list being exhaustive, protection against electrostatic discharges (ESD), a DC/DC conversion, a charge pump, a protection during switching or else the integration of sensors.

In order to better illustrate the subject matter of the present invention, a plurality of illustrative but non-limiting embodiments will now be described, in relation to the appended drawings.

### ON THE PRESENT DRAWINGS

FIG. A1 is a principle schematic diagram of a MEMS switch of the prior art, in the open position.

FIG. A2 shows a switch according to FIG. A1 in the closed position.

FIG. B1 is a principle schematic diagram of a MEMS switch according to the invention in the open position.

FIG. B2 shows a switch according to Figure B1 in the closed position.

FIG. 1 shows a MEMS switch according to a first embodiment of the invention, in side view in the open position.

FIG. 2 shows the MEMS switch of FIG. 1 seen along section AA of FIG. 1.

FIG. 3 shows the MEMS switch of FIG. 1 seen from above.

FIG. 4 shows the MEMS switch of FIG. 1 in a side view in the closed position.

FIG. 5A shows the MEMS switch of FIG. 1 in a side view in a more open position than in FIG. 1.

FIG. 5B shows the MEMS switch of FIG. 1 in a side view in yet another open position.

FIG. 6 shows the MEMS switch of FIG. 1 in another closed position.

FIG. 7 is a figure similar to FIG. 2 of a variant of the MEMS switch according to the first embodiment, with a partially open cavity.

FIG. 8 is a figure similar to FIG. 3 of the variant of the MEMS switch according to the first embodiment, with a cavity partially open.

FIG. 9 is a view similar to the view shown in FIG. 1 of a MEMS switch according to a second embodiment of the present invention.

FIG. 10 is a view similar to FIG. 2 of the MEMS switch according to the second embodiment.

FIG. 11 is a view similar to FIG. 3 of the MEMS switch according to the second embodiment.

FIG. 12 is a view similar to FIG. 4 of the MEMS switch according to the second embodiment.

FIG. 13A is a view similar to FIG. 1 of a MEMS switch according to a third embodiment of the present invention, in the rest position.

FIG. 13B is a view of the switch of FIG. 13A in the fully open position.

FIG. 13C is a view of the switch of FIG. 13A in the closed position.

FIG. 14A is a view of a variant of the switch of FIG. 13A in the rest position.

FIG. 14B is a view of the switch of FIG. 14A in the fully open position.

FIG. 14C is a view of the switch of FIG. 14A in the closed position.

FIG. 15 is a view similar to the view shown in FIG. 1 of a MEMS switch according to a fourth embodiment of the present invention, in the closed position.

FIG. 16 is a view similar to FIG. 1 of a MEMS switch according to the fourth embodiment of the present invention, in the open position.

FIG. 17 is a view similar to FIG. 1 of a MEMS switch according to a fifth embodiment of the present invention, in the closed position.

FIG. 18 is a view similar to the view shown in FIG. 1 of a MEMS switch according to the fifth embodiment of the present invention, in the open position.

FIG. 19 is a view similar to FIG. 1 of a MEMS switch according to a sixth embodiment of the present invention, in the open position.

FIG. 20 is a view similar to FIG. 1 of a MEMS switch according to the sixth embodiment of the present invention, in a closed position.

FIG. 21 is a view similar to FIG. 20 of a MEMS switch according to a variant of the sixth embodiment of the present invention, in the closed position.

FIG. 22 is a schematic view representing a first control circuit of a MEMS switch according to the variant of the sixth embodiment.

FIG. 23 is a schematic view showing a second control circuit of a MEMS switch according to the variant of the sixth embodiment.

FIG. 24A is a view similar to FIG. 1 of a MEMS switch according to a seventh embodiment of the present invention, in the rest position.

FIG. 24B is a view of the MEMS switch of FIG. 24A in the fully open position.

FIG. 24C is a view of the MEMS switch of FIG. 24A in the fully closed position.

FIG. 25 is a view similar to FIG. 1 of a MEMS switch according to an eighth embodiment of the present invention, in the open position.

FIG. 26 is a schematic representation of a MEMS switch according to a ninth embodiment of the present invention, in the closed position.

FIG. 27 is a schematic representation of a MEMS switch according to the ninth embodiment, in the open position.

FIG. 28 is a schematic representation of a MEMS switch according to a tenth embodiment, in a first open position.

FIG. 29 is a schematic representation of a MEMS switch according to the tenth embodiment, in the closed position.

FIG. 30 is a schematic representation of a MEMS switch according to the tenth embodiment, in a second open position.

FIG. 31 is a side view of a switch according to the present invention, containing MEMS switches.

FIG. 32 is a top view of the switch shown in FIG. 31.

FIG. 33 is an electrical diagram equivalent with the switch shown in FIG. 32.

FIG. 34 is a schematic representation of a component integrating a switch of FIG. 32.

FIG. A1, A2, B1 and B2 having already been described in the preamble will thus not be described again.

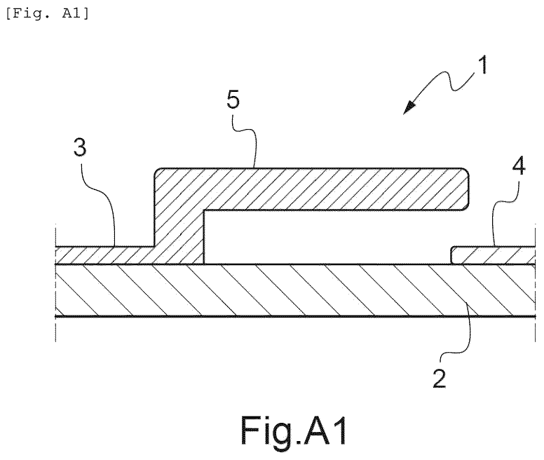

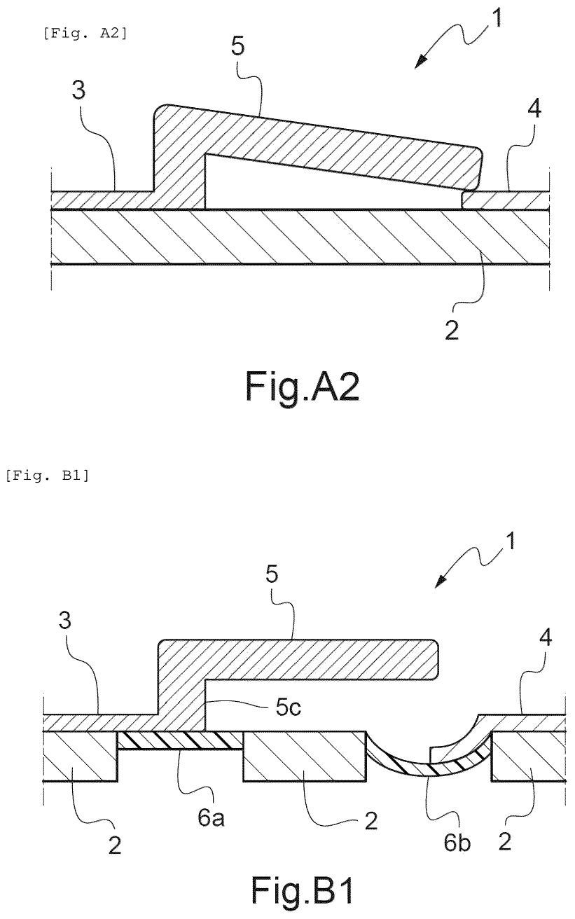

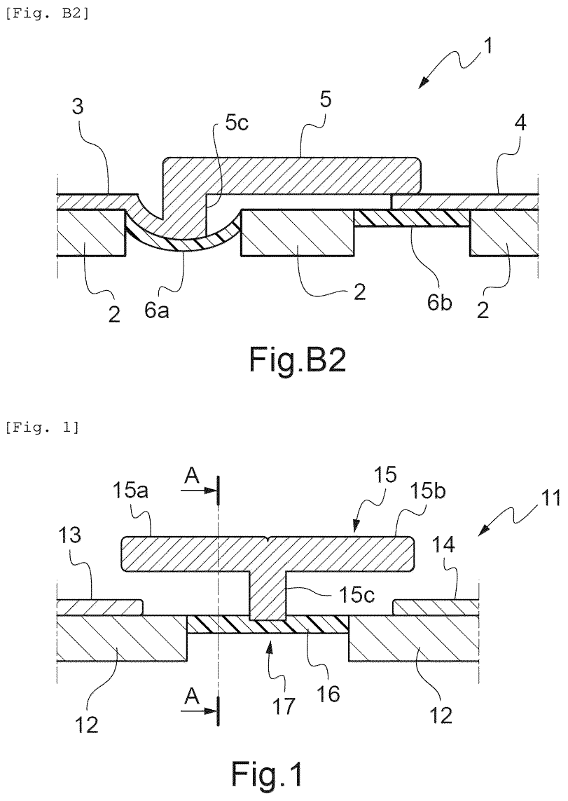

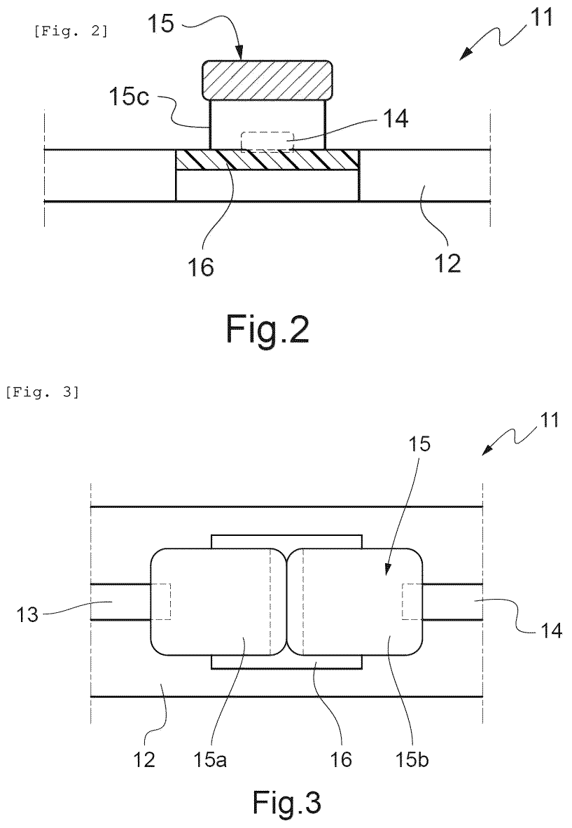

Referring to FIGS. 1 to 6, a MEMS switch 11 according to a first embodiment of the invention in side view in a plurality of positions, in front view along the line AA of FIG. 1 and in top view, is represented.

The MEMS switch 11 is formed on a substrate 12. A signal input line 13 and a signal output line 14 are formed on the surface of the substrate 12. Although a single signal input line 13 and a single signal output line 14 have been represented, the invention is not limited in this respect and can be applied to a plurality of signal input lines and/or a plurality of signal output lines, the person skilled in the art knowing how to design the architecture of the MEMS switch correspondingly.

A contact membrane 15, herein having the shape of a T with two cantilevered elements 15a and 15b, is formed on an anchoring base 16 covering a cavity 17 formed in the substrate 12.

The contact membrane 15 is anchored to the anchoring base 16 by means of an anchoring 15c, forming the trunk of the T, formed on the upper surface of the anchoring base 16.

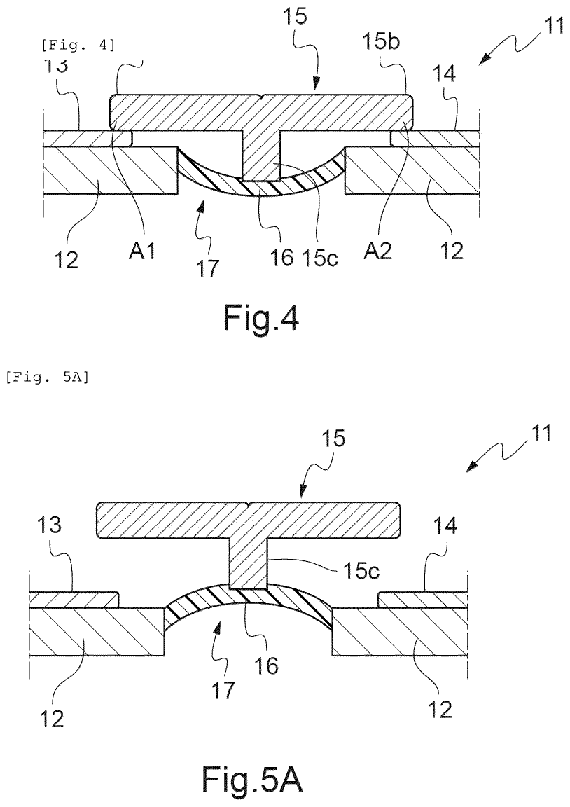

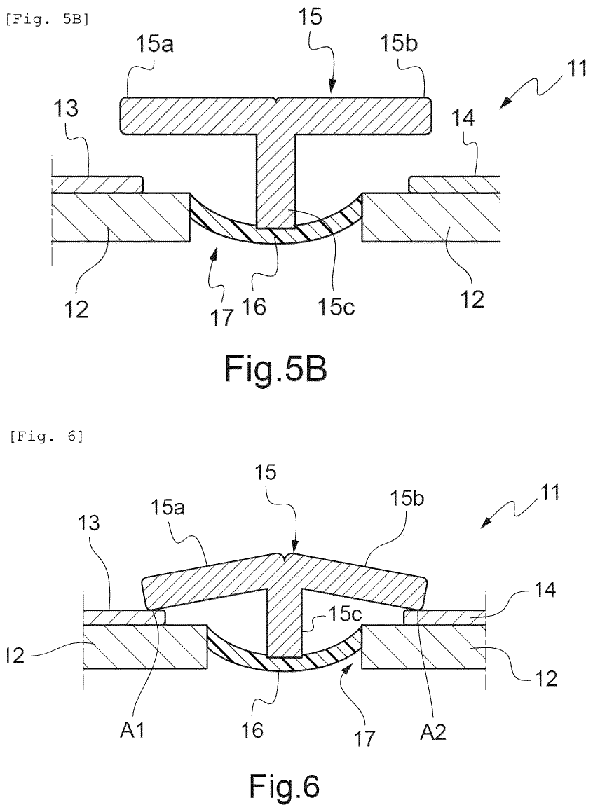

In such embodiment, the anchoring base 16 is deformable by a first means of actuation, described in greater detail hereinafter, either by downward bending as in FIGS. 4, 5B and 6, or by upward bending as in FIG. 5A. It should be of course understood that the contact membrane 15 and the anchoring base 16 can be independently prestressed and thus initially bent upwards, downwards, or not bent. A person skilled in the art will know how to choose, depending on the application, the initial position of the anchoring base 16, and the means of actuation making it possible to deform the anchoring base 16 in all the positions illustrated.

The provides electrical contact membrane 15 the connection between the signal input line 13 (also shortened to input line in the present application) and the signal output line 14 (also shortened to output line in the present application).

Thereby, in FIGS. 1, 2 and 5A-5B, the contact membrane 15 is not in contact with either the input line 13 or the output line 14: no current can flow between the input line 13 and the output line 14 and the MEMS switch 11 is thus open, no electrical path existing between the input line 13 and the output line 14. In said figures, the displacement of the contact membrane 15 is obtained by electrostatic, thermal, piezoelectric or magnetic actuation (not shown).

In FIG. 5A, the MEMS switch 11 is in the fully open position, the contact membrane 15 being in the position thereof furthest from the input line 13 and from the output line 14.

In FIG. 5B, the MEMS switch 11 is in another open position, the contact membrane 15 not being in contact with the input line 13 and with the output line 14 but being in a position less distant than in FIG. 5A.

In FIGS. 4 and 6, the MEMS switch 11 is closed, the contact membrane 15 being in contact, via the branch 15a thereof with the input line 13 and via the branch 15b thereof with the output line 14.

In FIG. 4, the simple bending of the anchoring base 16 suffices to achieve contact via the contact membrane 15, in other words a single means of actuation, the means of actuation of the anchoring base 16, is needed for closing the MEMS switch 11. The other means of actuation disposed at the contact membrane 15 provides more contact force in such case.

In FIG. 6, the simple bending of the anchoring base 16 is not sufficient to achieve contact. In such case, the deformation of the two branches 15a and 15b of the contact membrane 15, by a second means of actuation described in greater detail hereinafter, makes it possible, in addition to bringing the contact membrane 15 closer together due the deformation of the anchoring base 16, to make contact with the input line 13 and the output line 14, if the travel of the contact membrane 15 during maximum bending of the anchoring base 16 does not allow the branches 15a and 15b to come into contact with the input line 13 and the output line 14. The contact of the branches 15a and 15b of the contact membrane 15 with the input line 13 and the output line 14 takes place at the contact zones, A1 and A2 (identified in FIG. 4), respectively, which are of variable extension depending on the cantilever of the branches 15a and 15b of the contact membrane 15 above the input 13 and output 14 lines and of the height of the contact membrane 15 above the surface of the substrate 12. The contact membrane 15 may also have a dimple (not shown) if same provides better mechanical stability to the contact and better isolation.

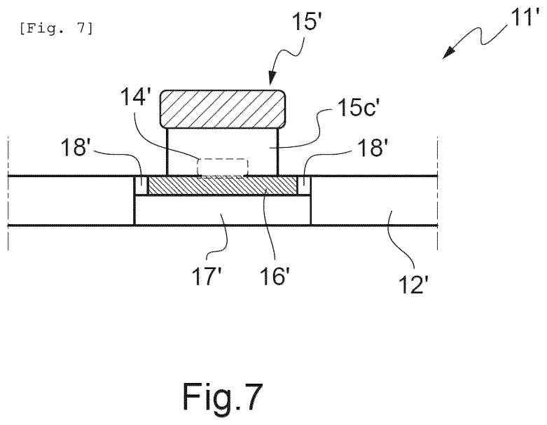

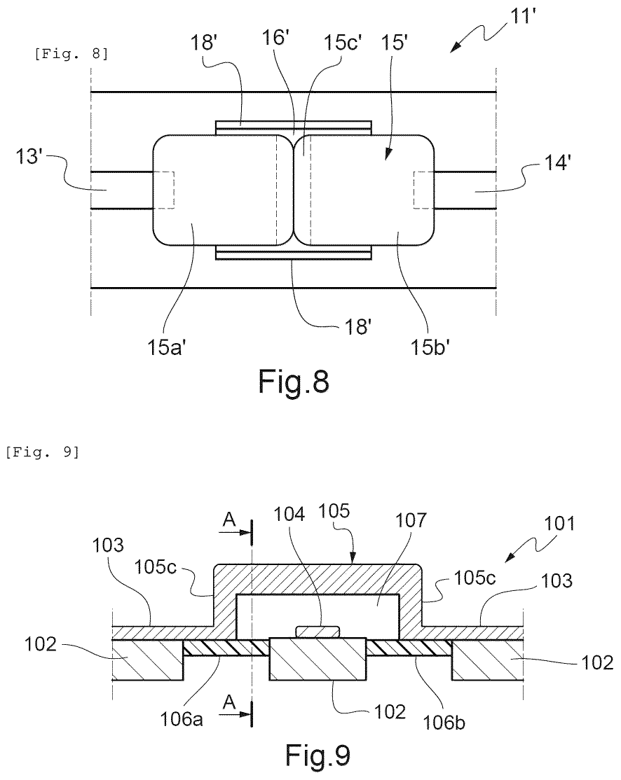

Referring now to FIGS. 7 and 8, it can be seen that a variant 11′ of the MEMS switch according to the first embodiment has been shown therein.

In such variant, the anchoring base 16′ only partially covers the cavity 17′, two elongated through holes 18′ being formed on each side between the anchoring base 16′ and the substrate 12′, the structure of the contact membrane 15′, with the two branches 15′a and 15′b and the anchoring 15′c thereof on the anchoring base 16′, the input line 13′ and the output line 14′ being identical to the structure described for the MEMS switch of FIGS. 1-6 and thus not being described in more detail (the common elements bearing the same reference number with the character “′” after the associated reference number).

In the two variants of the first embodiment (with a closed or semi-open anchoring base), the anchoring base 16, 16′ and the contact membrane 15, 15′ can be deformed by any means (electrostatic, piezoelectric, magnetic, thermal). The surface under the input line 13, 13′ and under the output line 14, 14′ at the contact zones A1 and A2 in the two variants of the first embodiment consists of the substrate. The surface, identified by the contact zone base, is hence non-deformable in the first embodiment.

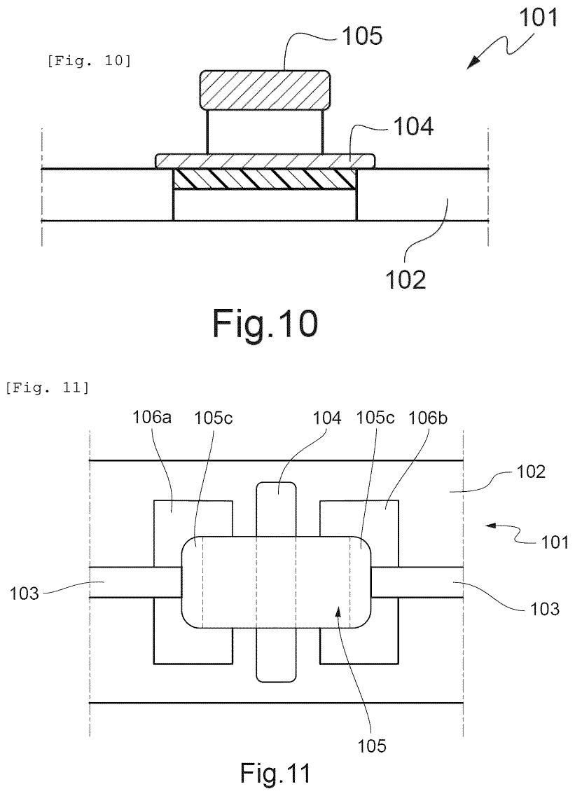

Referring now to FIGS. 9 to 12, it can be seen that a is MEMS switch 101 according to a second embodiment, represented therein.

The MEMS switch 101 is formed on a substrate 102, with a signal input line 103 formed integrally with the contact membrane 105, forming a bridge over the signal output line 104, formed transversely on the substrate 102 with respect to the direction of the input line 103. The output line 104 is thus formed in the space 107 under the contact membrane 105.

In the second embodiment, the contact membrane 105 comprises two anchorings 105c, to be on each side of the signal output line 104.

The two anchorings 105c are each formed on an anchoring base, 106a, 106b, respectively, deformable as in the first embodiment. As for the first embodiment, the surface under the contact zones between the contact membrane and the input 103 and output 104 lines consists of the substrate. The surface, identified by the contact zone base, is thus non-deformable in the second embodiment.

Thereby, in the open configuration shown in FIG. 9, the anchoring bases 106a, 106b are not deformed, and the contact membrane 105 does not electrically connect the signal input line 103 to the signal output line 104, no electrical path being created therebetween.

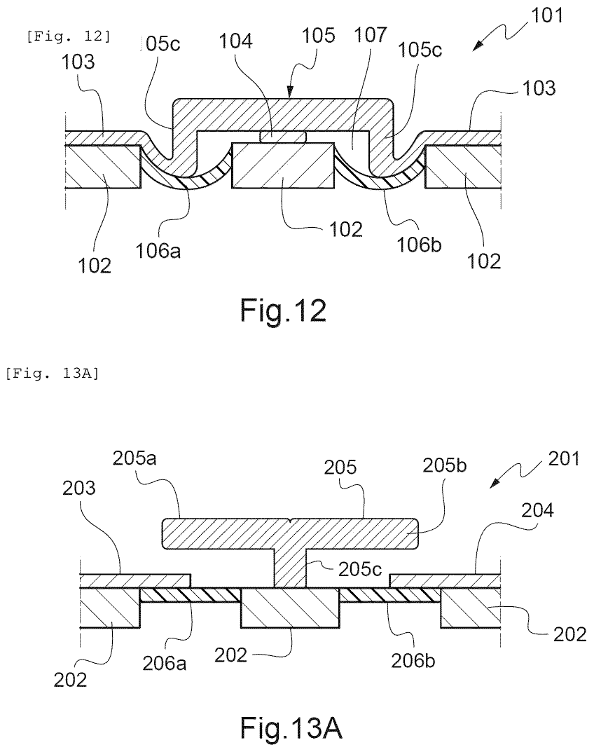

In the closed configuration shown in FIG. 12, the two anchoring bases 106a, 106b are deformed, with a downward bending in FIG. 12 leading to a displacement of the contact membrane 105 toward the signal output line 104, by lowering the anchorings 105c downwards. The means of actuation present at the contact membrane 105 (not shown) in the present case also provides more contact force.

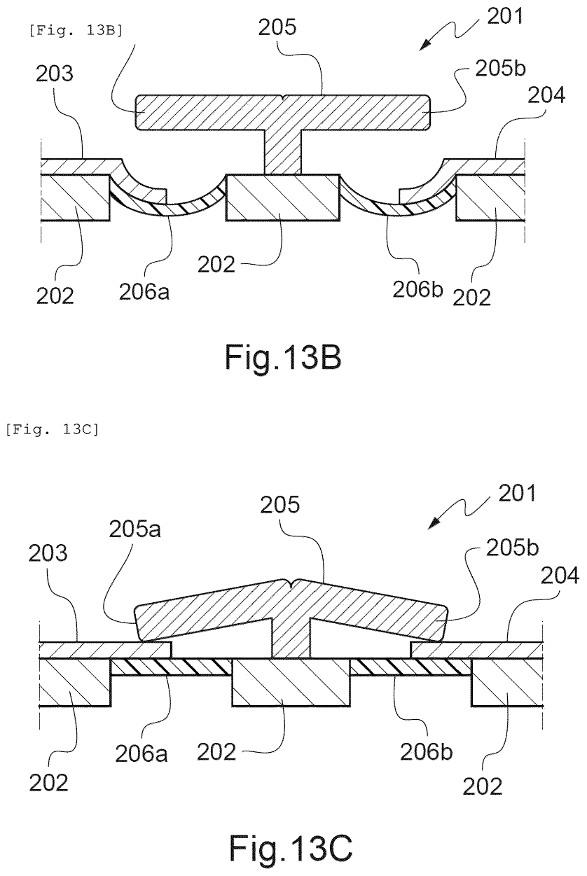

Referring now to FIG. 13A-13C, it can be seen that a MEMS switch 201 according to a third embodiment is represented therein. The actuation is not shown so as not to overload the figures.

The MEMS switch 201 comprises a T-shaped contact membrane 205, comprising an anchoring 205c forming the trunk of the T and two branches 205a, 205b forming the cap of the T. The anchoring 205c is formed directly on the substrate 202, the anchoring base identifying the surface on which the anchoring 205c bears, being thus, in the present embodiment, non-deformable.

The input line 203 is formed partially on the substrate 202 and partially on a first contact zone base 206a formed partially right below the branch 205a of the contact membrane 205, and the output line 204 is formed partially on the substrate 202 and partially on a second contact zone base 206b formed partially right below the branch 205b of the contact membrane 205.

Thereby, for the switch 201 according to the third embodiment, a first means of actuation (not shown) allows the branches 205a, 205b of the contact membrane 205 to bend toward the input line 203 and toward the output line 204, respectively, a second means of actuation (not shown) being configured to make the contact zone bases 206a and 206b bend, which by the actuation thereof make it possible to move the signal input line 203 and the signal output line 204 closer to or away from the branches 205a and 205b of the contact membrane 205.

Thereby, FIG. 13A shows the rest position of the MEMS switch 201. The distance of the contact membrane 205 with respect to the signal input line 203 and the signal output line 204 is not maximum, however there is no connection and the MEMS switch 201 is thus open.

FIG. 13B shows a position wherein the deformable contact zone bases 206a and 206b are activated so as to bend downwards and move the input line 203 and the output line 204 away from the contact membrane 205. The distance between the contact membrane 205 and the input line 203 and the output line 204 is thus greater than in FIG. 13A, the position of FIG. 13B thus represents the fully open position of the switch 201.

FIG. 13C shows the closed position of the switch 201: the contact zone bases 206a and 206b are not activated to bend but the two branches 205a, 205b of the contact membrane 205 are activated to bend toward the input line 203 and the output line 204.

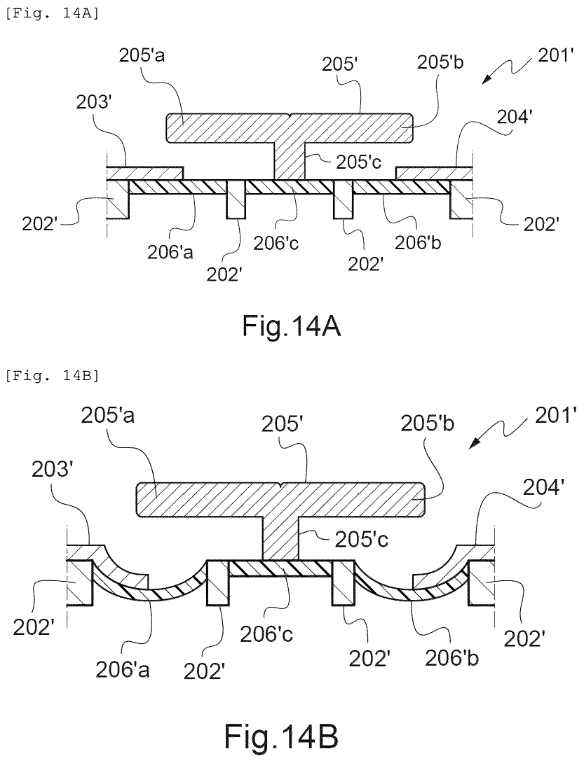

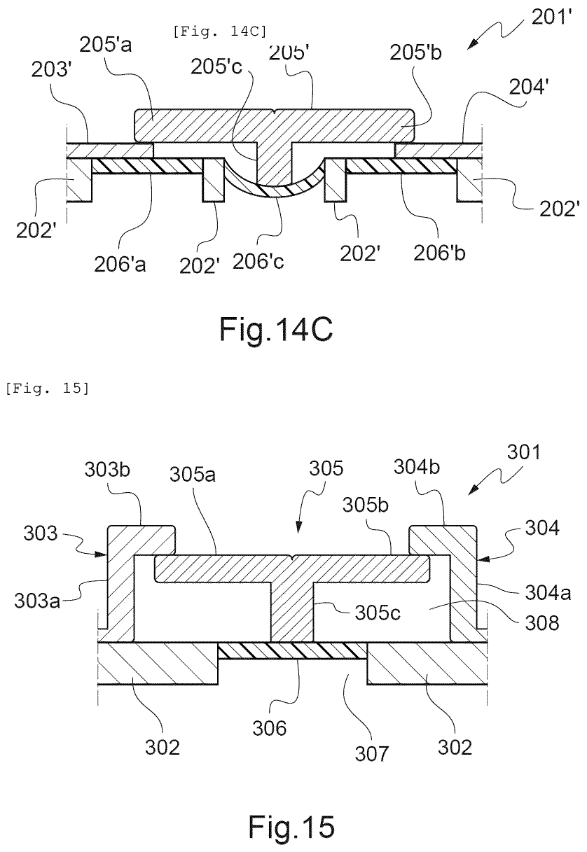

Referring now to FIG. 14A-14C, it can be seen that a MEMS switch 201′ according to a variant of the third embodiment is represented therein.

The elements common with FIGS. 13A-13C bear the same reference number with a character “‘” after the associated reference number and will not be described in more detail.

The difference in such variant, with respect to the MEMS switch 201 of FIGS. 13A-13C, lies in the presence of a deformable anchoring base 206′c formed in the substrate 202′ under the anchoring 205′c of the contact membrane 205′.

In FIG. 14A, the MEMS switch 201′ is in the open position: the branches 205′a and 205′b of the contact membrane 205 are not in contact with the input line 203′ and with the output line 204′.

In FIG. 14B, the MEMS switch 201′ is in the fully open position: similar to FIG. 13B, the deformable contact zone bases 206′a and 206′b are activated to move the input line 203′ and the output line 204′ away from the contact membrane 205′.

FIG. 14C shows that the switch 201′ is closed not by bending the branches 205′a and 205′b as in FIG. 13C, but by actuating the anchoring base 206′c, the contact zone bases 206′a and 206′b remaining not actuated.

It should be noted that such embodiment does not exclude an actuation of the branches 205′a and 205′b in order to reinforce the contact thereof with the input line 203′ and the output line 204′, respectively.

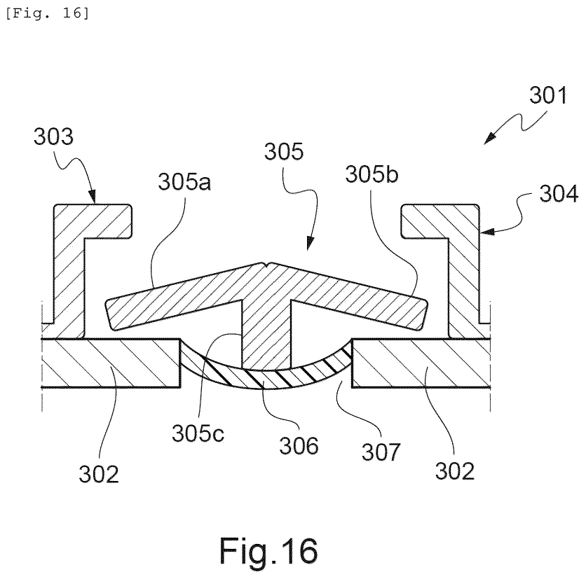

Referring now to FIGS. 15 and 16, it can be seen that a MEMS switch according to a fourth embodiment, is represented therein.

In the fourth embodiment, the MEMS switch 301 is formed on a substrate 302.

A signal input line 303 is formed with a portion on the substrate 302, a vertical portion 303a and a cantilever portion 303b above the substrate 302.

Similarly, a signal output line 304 is formed with a portion on the substrate 302, a vertical portion 304a and a cantilever portion 304b above the substrate 302.

The contact membrane 305 is formed in the space 308 under the cantilevered parts 303b and 304b of the input line 303 and of the output line 304 and has substantially the same T shape as in the first embodiment, with two branches 305a and 305b supported by an anchoring 305c corresponding to the trunk of the T, formed on a deformable anchoring base 306 closing a cavity 307 (shown only partially in the figures) formed in the substrate 302.

In the fourth embodiment, when the MEMS switch 301 is in the state where the anchoring base 306 is not deformed, the branches 305a, 305b of the contact membrane are in contact with the lower part of the cantilevered parts 303b and 304b of the input line 303 and of the output line 304, respectively, forming an electrical contact between the input and output of the MEMS switch 301, which is thus normally closed, unlike in the other embodiments described hitherto.

As for the other embodiments, the MEMS switch 301 has two deformable elements, the contact membrane 305 and the anchoring base 306, an actuation of the anchoring base 306 bending same toward the inside of the substrate 302, making the anchoring 305c and hence the entire contact membrane 305 descend, and an actuation of the contact membrane allowing the branches 305a, 305b of the contact membrane 305 to deform toward the substrate 302.

The two actuation levels lead to a better electrical isolation between the input and output of the MEMS switch 301 in the open state thereof shown in FIG. 16. The contact zone base, which is not deformable in such embodiment, is formed by the surface of the substrate 302 under the vertical parts 303a and 304a.

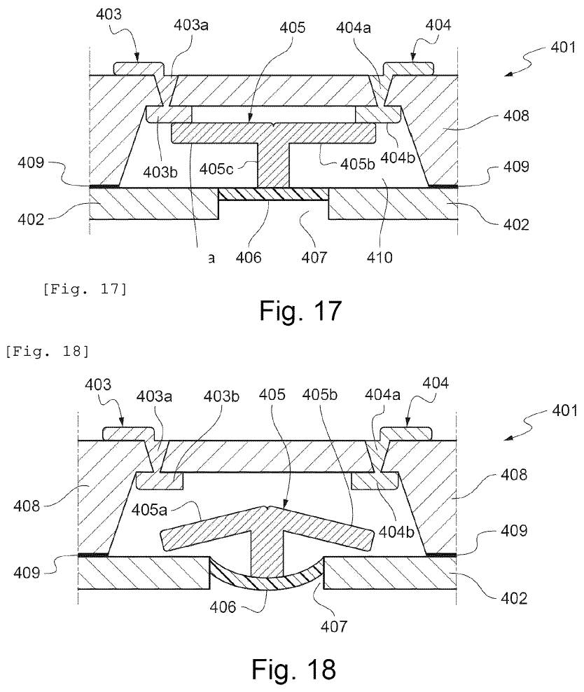

Referring now to FIGS. 17 and 18, it can be seen that a MEMS switch 401 according to a fifth embodiment is represented therein.

The fifth embodiment is similar to the fourth embodiment in that the MEMS switch 401 is normally closed.

The MEMS switch 401 is thus formed on a substrate 402.

Another substrate 408 is bonded to the substrate 402 by a connecting line 409.

The input line 403 and the output line 404 are formed on the upper surface of the substrate 408 and extend through the substrate 408 via vias, 403a and 404 a, respectively, so as to form in the ceiling of a space 410 between the two substrates 402 and 408 two contact pads, 403b and 404b, respectively.

The contact membrane 405 is, as in the preceding embodiment, T-shaped with two cantilevered branches 405a and 405b above the upper surface of the substrate 402, supported by an anchoring 405c supported by a deformable anchoring base 406 closing a cavity 407.

In the normally closed state in FIG. 17, the branches 405a, 405b, respectively, of the contact membrane 405, are in contact with the contact pads 403b and 404b, respectively, of the input lines 403 and 404, so as to form an electrical path between the input and the output of the MEMS switch 401.

As for the other embodiments, the MEMS switch 401 has two means of actuation, a first means of actuation serving for the deformation of the anchoring base 406 toward the direction of depth of the cavity 407, making the anchoring 405c and thus the entire contact membrane 405 descend, and a second means of actuation serving for the deformation toward the substrate 402 of the branches 405a, 405b of the contact membrane 405.

The two means of actuation provide better electrical isolation between the input and output of the MEMS switch 401 in the open state thereof shown in FIG. 18. The contact zone base, which is not deformable in this embodiment, is formed by the surface of the substrate 402 under the connecting lines 409.

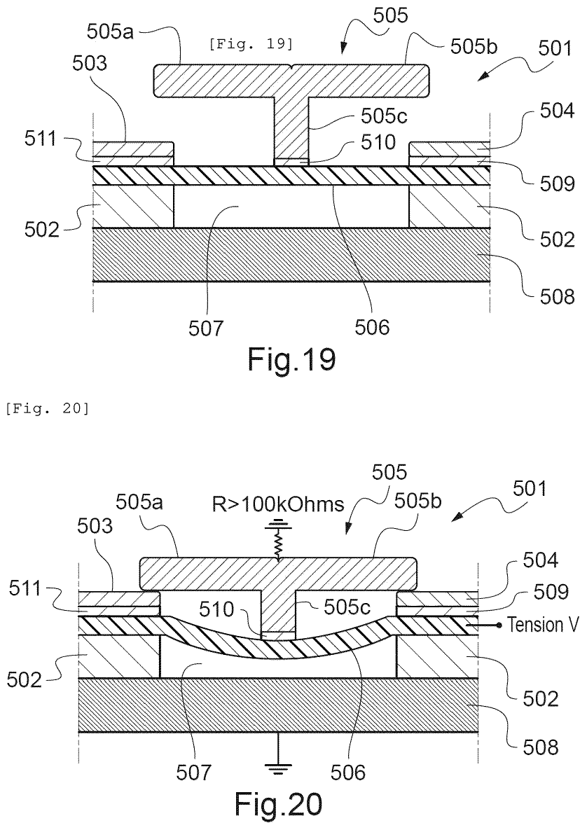

Referring to FIGS. 19 to 23, it can be seen that a MEMS switch 501 according to a sixth embodiment, is represented therein.

In the sixth embodiment, a silicon-on-insulator (SOI) substrate structure is adopted, the substrate 508 being made of silicon.

An insulating layer, as a non-limiting example, of SiO₂ 502 is formed on the substrate 508, with a cavity 507 formed in the SiO₂ layer 502, the cavity 507 being closed at the upper end thereof by a silicon layer 506, acting as a deformable anchoring base, on which rests the contact membrane 505, shaped as a T with two branches 505a and 505b cantilevered above the layer 506, and a trunk 505c acting as anchoring, a layer of SiO₂ 510 being interposed between the base of the anchoring 505c and the anchoring base 506.

The input line 503, respectively the output line 504, is formed on the layer 506, with interposition of a layer of SiO₂ 511, respectively 509.

It should be noted that the layer 506 can completely or partially close the cavity 507, without the invention being limited in such respect.

The input line 503, the output line 504 and the contact membrane 505 are made of an electrically conductive material or alloy of materials. As a variant, the contact membrane 505 may consist of a plurality of layers, including at least one conductor intended to come into contact with the input 503 and output 504 lines.

In FIG. 19, the MEMS switch 501, normally open, is in the open state. The branches 505a and 505b of the contact membrane 505 are cantilevered above the input 503 and output 504 lines.

In FIG. 20, the MEMS switch 501 is in the closed state, with the two deformable elements (contact membrane 505 and anchoring base 506) deformed.

Since the substrate 508 is grounded, a voltage V is applied to the layer 506. The voltage V may be positive or negative but is sufficiently high for the induced electrostatic force to generate a force enabling the anchoring base 506 to be deformed.

Thereby, the difference of potential between the layer/anchoring base 506 and the substrate 508 forming the first means of actuation of the anchoring base 506 will cause, by electrostatic effect, a bending of the part of the layer 506 forming the anchoring base toward the interior of the cavity 507.

Similarly, the difference of potential between the layer 506 and the branches 505a and 505b of the contact membrane 505 forming a second means of actuation will cause the branches 505a and 505b to be pressed against the signal input line 503 and the signal output line 504, respectively.

In FIG. 20, a high-value (greater than 100 kOhms) resistor connected to ground enables the ground to be indirectly connected to the contact membrane 505 when the MEMS switch 501 is open. When contact is made between the contact membrane 505 and the input line 503 and the output line 504 as in FIG. 20, the resistance is too high to affect the transmitted electrical, electronic or radiofrequency signal.

As a variant, it would be conceivable to dissociate the signal line from the ground within the membrane as described in European patent application EP 3465724. Such variant would make it possible in particular to dispense with the resistor connected to the ground.

The first means of actuation is thus the difference of potential applied between the layer 506 and the substrate 508, and the second means of actuation is the difference of potential between the layer 506 and the contact membrane 505. The actuation described herein is an actuation by electrostatic field created by difference of potential, but other actuations are conceivable within the scope of the present invention, e.g. piezoelectric actuation (displacement or deformation by piezoelectric effect), magnetic actuation (controlled magnets permit a deformation of the anchoring base 506 and/or a displacement of the contact membrane 505) or thermal actuation (a controlled temperature modifies the shape of the anchoring base 506 and/or of the contact membrane 505).

The contact zones, formed by the surface situated under the part of the input line 503 and under the part of the output line 504 in contact with the contact membrane 505 in FIG. 20, are formed on the substrate 508. The contact zone bases, defined as the surface under the contact zone, are thus not deformable in such embodiment.

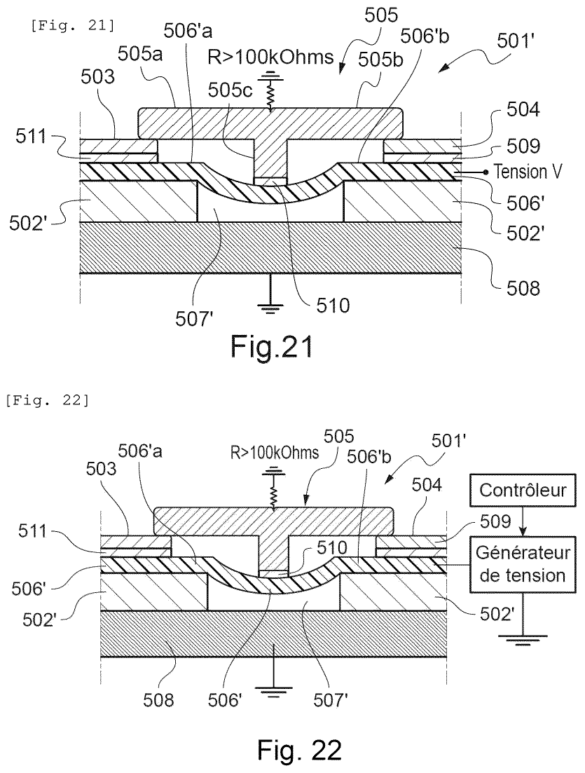

FIG. 21 represents a variant of the sixth embodiment of the MEMS switch 501′.

In such variant, the elements common to same of FIGS. 19 and 20 will bear the same reference number and will not be described in more detail.

In such variant, it can be seen that the SiO₂ layer 502′ formed between the substrate 508 and the layer 506′ extends under the input line 503 and under the output line 504 (whereas in FIGS. 19 and 20, the SiO₂ layer 502 is at right under the end of the input line 503 and of the output line 504) so as to form a narrower cavity 507′. Consequently, rectilinear parts 506′a and 506′b are formed on the protruding parts of the layer 506′ with respect to the ends of the input line 503 and of the output line 504.

As in FIG. 20, there are two means of actuation with deformation of the layer 506′ by difference of potential between the layer 506′, to which a voltage V is applied, and the substrate 508, at the ground, and deformation of the branches 505a and 505b, by difference of potential between the layer 506′, at voltage V, and the branches 505a and 505b of the contact membrane 505, connected by a high resistance (>100 kOhms) to ground.

Thereby, by actuating the anchoring base 506′, the branches 505a and 505b of the contact membrane 505 close the MEMS switch 501′ while remaining parallel to the surface of the substrate 506. The parallelism between the SOI substrate membrane 505 508 and the contact provides a higher electrostatic field on the means of actuation of the contact membrane 505 and provides a better contact force. Same also limits the mechanical forces of the contact membrane and allows the person skilled in the art to use conventional materials.

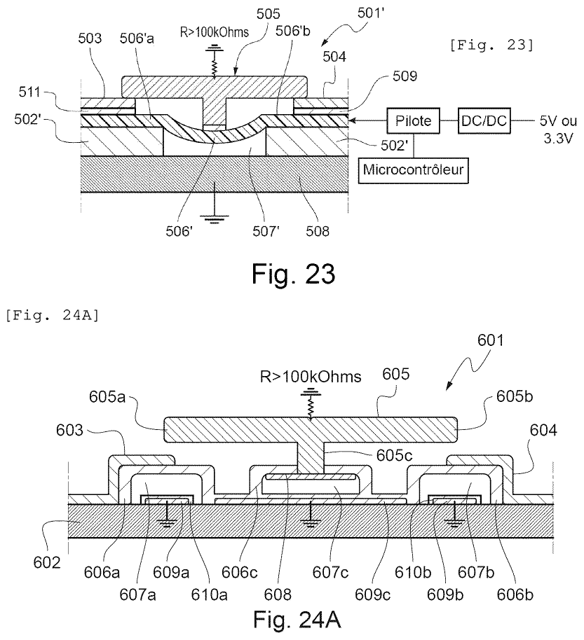

FIGS. 22 and 23 illustrate two variants for applying a difference of potential between the layer 506′ and the contact membrane 505 and the layer 506′ and the substrate 508.

In the variant shown in FIG. 22, a controller, which may be, without limitation, any electronic circuit such as a processor, a microprocessor, a microcontroller, a digital signal processor, a Field Programmable Gate Array (FPGA), an application specific integrated circuit (ASIC), or even a computer, controls a voltage generator which applies the voltage V to the layer 506′, the contact membrane 505 and the substrate 508 being at the ground.

In the variant shown in FIG. 23, a driver controlled by a microcontroller applies a voltage V on the layer 506′, obtained by a DC/DC converter supplied with a voltage of 3.3 V or 5 V, the contact membrane 505 and the substrate 508 being at the ground.

The two modes of application of a voltage V are described as an illustration, but without being limited thereto, the invention not being limited in such respect.

A person skilled in the art would be able to appreciate, depending on the design and architecture of the MEMS switch, how to create a difference of potential in order to obtain a deformation of the anchoring base on which the contact membrane rests and a displacement of the membrane. The same applies to contact zone bases when same are deformable.

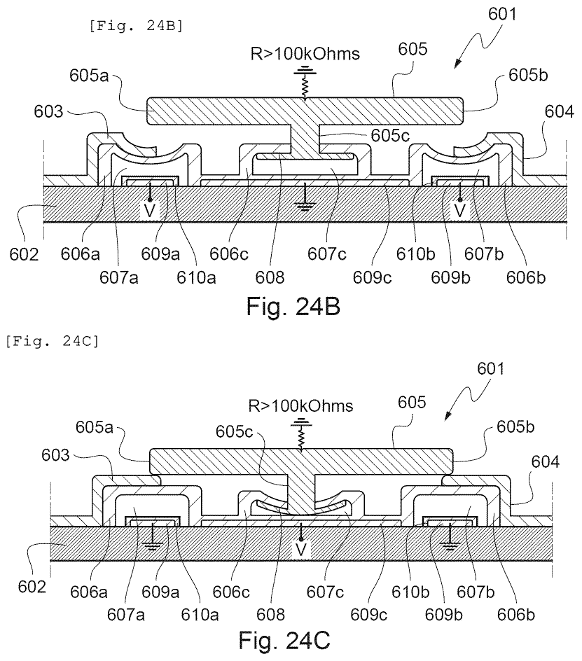

Referring now to FIG. 24A-24C, it can be seen that a MEMS switch 601 according to a seventh embodiment, is represented therein.

In such embodiment, the cavity permitting the deformation is not formed in the substrate, but above same.

The MEMS switch 601 comprises an insulating substrate 602, to the upper surface of which is attached a thin dielectric layer (without limitations, made of SiO₂, SiN, Ta₂O₅, Al₂O₃). The input line 603 and the output line 604, made of electrically conductive material or alloys of materials, are formed on the upper surface of the thin dielectric layer.

The contact membrane 605, made of electrically conductive material or alloys of materials, is, as in the other embodiments, T-shaped with two cantilevered branches 605a and 605b above the thin dielectric layer, and a trunk serving as a vertical anchoring 605c for the contact membrane 605, the base of the vertical anchoring 605c extending through the thin dielectric layer at a dome 606c formed by the thin dielectric layer and defining a cavity 607c, and extending into an electrode 608 applied to the upper internal surface of the cavity 607c. The upper face of the dome 606c forms a deformable anchoring base.

An electrode 609c is formed on the substrate 602 substantially right under the contact membrane 605, under the thin dielectric layer.

The input line 603 extends over a cavity 607a formed by a dome 606a formed by the thin dielectric layer. The upper face of the dome 606a forms a deformable contact zone base for the contact zone between the contact membrane 605 (branch 605a) and the input line 603.

An electrode 609a is formed in the bottom of the cavity 607a, covered by an insulating layer 610a.

In the same way, the output line 604 extends over a cavity 607b formed by a dome 606b formed by the thin dielectric layer. The upper face of the dome 606b forms a deformable contact zone base for the contact zone between the contact membrane 605 (branch 605b) and the output line 604.

An electrode 609b is formed in the bottom of the cavity 607b, covered by an insulating layer 610b.

FIG. 24A shows the rest position, the membrane 605 and the electrodes 609a, 609b and 609c being connected directly or indirectly (via a high resistance) to the ground.

In FIG. 24B, the electrodes 609a and 609b are activated by a voltage V in order to move the input line 603 and the output line 604 away from the contact membrane 605, the MEMS switch 601 then being in the fully open position.

In FIG. 24C, the electrode 609c is activated by a voltage V, the other elements remaining at the ground, in order to lower the contact membrane 605 into contact with the input line 603 and with the output line 604: the MEMS switch 601 is in the closed position.

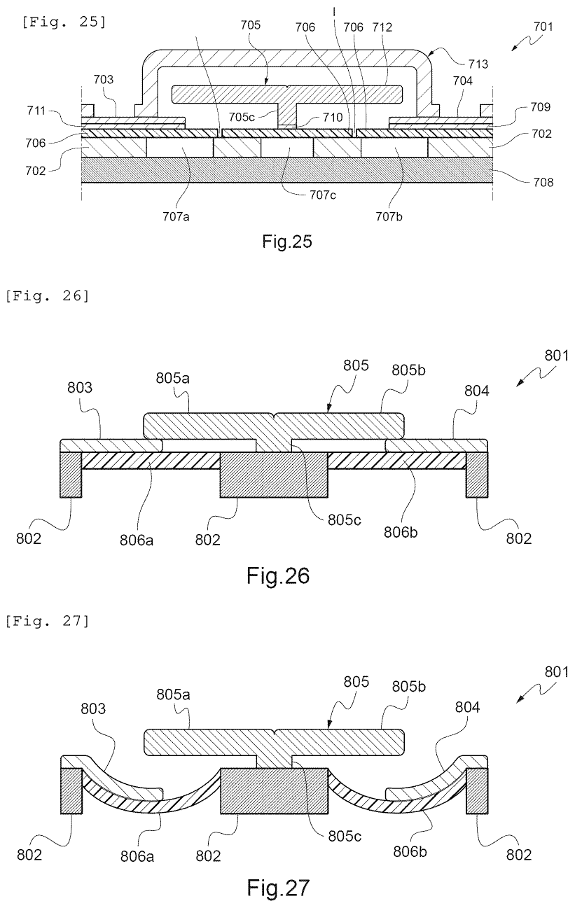

FIG. 25 shows a MEMS switch 701 according to a seventh embodiment.

In such embodiment, the MEMS switch 701 comprises a T-shaped contact membrane 705 resting on an anchoring 705c.

The MEMS switch 701 is formed on a substrate 708 on which a layer 702 is formed, wherein three cavities 707a, 707b and 707c are formed, under the input line 703, the output line 704 and the anchoring 705c, respectively,, the cavities being covered and closed by a layer 706 insulated from the input line 703, the output line 704 and the base of the anchoring 705c, respectively, by insulating layers 711, 710 and 709, respectively. Openings I in the layer 706 make it possible to electrically insulate the different pieces of the layer 706.

Encapsulation is created by a cup 713 formed e.g. of a thin film dielectric (SiO₂, SiN, Ta₂O₅, Al₂O₃ e.g.), defining an encapsulation space wherein the switch 701 is located and creating a hermetic cavity 712 on the contact membrane 705.

The cavity 712 can in particular be filled with gas and serves to make the switch 701 more robust.

The operation of the switch 701 is otherwise identical to what was described hereinabove and will not be repeated in detail herein.

The cavity 712 comprises a gas or vacuum and may or may not be under pressure with respect to the outside of the encapsulation space.

For all the embodiments described hitherto, the cavity present under the anchoring base on which the contact membrane is anchored, may also comprise a gas or vacuum, and may or may not be under pressure with respect to the outside of the MEMS switch.

For all the embodiments described, the anchoring of the contact membrane will preferably be arranged right at the point of maximum bending of the anchoring base, in order to permit the longest possible travel.

It should of course be understood that the person skilled in the art would be able to size the height of the contact membrane, the length of the branch or branches of the contact membrane intended to come into contact with the input and output lines according to the layout of the input and output lines, in order to obtain the desired isolation in the open position and the desired contact force in the closed position. The second means of actuation present at the contact membrane (not shown) also provides, in such case, more contact force.

In such embodiment, the contact membrane 705, the anchoring base closing the cavity 707c and the contact zone bases closing the cavities 707a and 707b are deformable. The means of actuation of these different deformable elements may be, without limitation, as described hereinabove.

Referring to FIGS. 26 to 27, it can be seen that a MEMS switch 801 according to a ninth embodiment, is represented therein.

The switch 801 comprises a substrate 802 on which is formed a contact membrane 805, an input line 803, an output line 804, and two deformable contact zone bases 806a, 806b, extending not as in the other embodiments under the anchoring 805c of the contact membrane 805, but under the ends of the input line 803 and output line 804 intended to come into contact with the branches 805a and 805b of the contact membrane 805 to form the contact zones with the latter. The anchoring base, the surface on which the anchoring bears, is non-deformable in such embodiment.

Thereby, unlike in the other embodiments described hitherto, instead of moving the contact membrane 805 closer to or further away from the fixed input and output lines 803 and 804, it is the contact membrane 805 that is fixed and the input 803 and output lines 804 that move, a means of actuation of the contact membrane 805 being further provided to enable the contact membrane 805 to be deformed.

In FIG. 26, the normally closed switch 801 has the contact membrane 805 thereof in contact with the input 803 and output 804 lines, the respective contact zone bases 806a and 806b being in the non-deformed states thereof.

The means of actuation present at the contact membrane 805 (not shown) in the present case also provides more contact force.

In FIG. 27, the switch 801 is in the open position, with the contact zone bases 806a and 806b deformed by downward bending, in a manner similar to what described in connection with the preceding embodiments, to move the input 803 and output 804 lines away from the contact membrane 805, so as to obtain an open position of the MEMS switch 801.

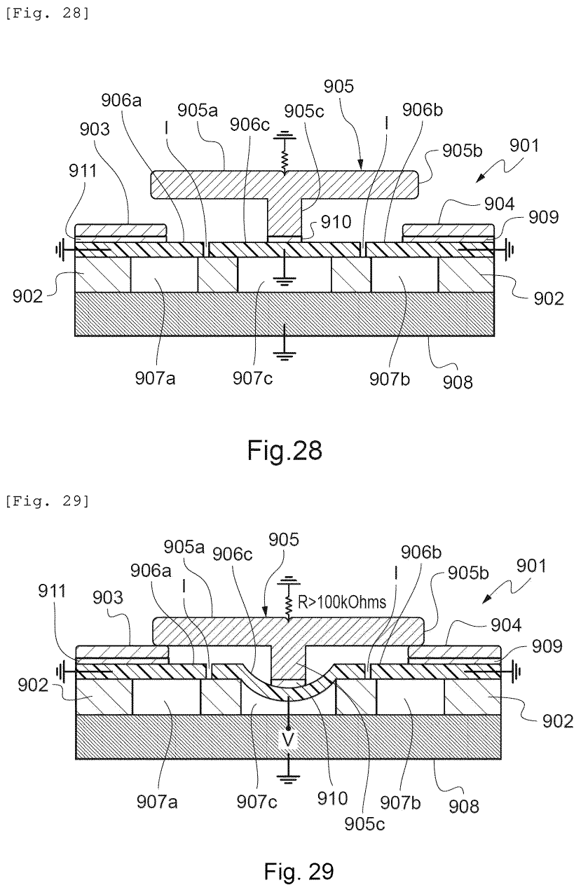

Referring to FIGS. 28 to 30, a MEMS switch 901 according to a tenth embodiment has been shown, representing a combination of the ninth embodiment with the preceding embodiments.

In the tenth embodiment, the SOI structure switch 901 has a silicon substrate 908, an SiO₂ layer 902 wherein cavities 907a, 907b, 907c covered by a silicon layer are formed to form three deformable bases, contact zone bases 906a, 906b and an anchoring base 906c, respectively, electrically insulated from each other by openings I correspondingly formed in the silicon layer.

The first contact zone base 906a is located under the end of the input line 903, the second anchoring base 906c is located under the anchoring 905c of the contact membrane 905, the third contact zone base 906b being located under the end of the output line 904.

The contact membrane 905, comprising the branches 905a, 905b and the anchoring 905c thereof, is made of an electrically conductive material or alloy of materials, just as the input line 903 and the output line 904. As a variant, the contact membrane 905 may consist of a stack of a plurality of materials or even have a waveguide structure as described hereinabove with reference to FIG. 20.

SiO₂ layers 909, 910 and 911 are formed under the output line 904, the anchoring 905c and the input line 903, respectively.

In FIG. 28, the contact membrane 905 is indirectly connected to the ground via a high resistance (>100 kOhms), the contact zone bases 906a, 906b, the anchoring base 906c, and the substrate 908 are directly connected to ground.

The switch 901 is hence at rest.

In FIG. 29, the base 906c under the anchoring 905c of the contact membrane 905 is connected to the voltage V (in a manner similar to what was described in connection with FIGS. 19 to 23), the other elements remaining directly or indirectly connected to ground: the switch 901 is in the closed position.

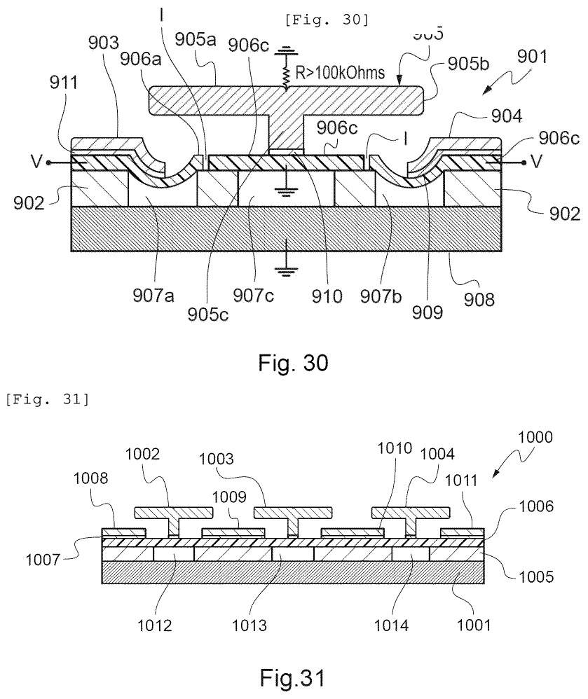

In FIG. 30, the contact zone bases 906a and 906b, under the input line 903 and the output line 904, respectively, are connected to the voltage V, the other elements, including the contact membrane 905, are directly or indirectly maintained to the ground.

The downward deformation of the contact zone bases 906a and 906b moves the input line 903 and the output line 904 away from the branches 905a and 905b of the contact membrane 905, leading to a second open position of the switch 901, wherein the isolation obtained is stronger: the MEMS switch 901 is in the fully open position.

It can thus be seen that different states of the MEMS switch can be obtained, wherein either the contact force in the closed state is greater, or the isolation in the open state is greater, depending on the location of the deformable bases, under the anchorings of the contact membrane and/or under the contact zones of the input and/or output lines.

It should be of course understood that the embodiment wherein a deformable contact zone base is arranged under the signal lines is also applicable to cases where the contact membrane is connected to the input or output line, the deformable contact zone base then being arranged under the line among the input line and the output line which is not connected to the contact membrane. The difference of potential between the anchoring base 906c and the contact membrane also provides, in such case, more contact force.

Table 1 below indicates some of possible the configurations permitted by a MEMS switch according to the present invention, high meaning that the element in question is deformable with an upward deformation, low representing that the element in question is deformable with a downward deformation, − meaning the fact that the element is not deformable, NO representing a normally open switch, NC representing a normally closed switch, + an improvement of the considered parameter compared to the prior art, ++ a strong improvement of the considered parameter compared to the prior art.

TABLE 1

| Contact | Anchoring | Contact | | Advantages | |
|---|---|---|---|---|---|
| membrane | base | zone base | | Contact | |
| actuation | actuation | actuation | Type | force | Isolation |
| Low | Low | — | NC | + | |
| Low | Low | — | NO | | + |
| High | Low | — | NC | | + |
| Low | High | — | NO | + | |
| High | High | — | NC | + | |
| High | High | — | NO | | + |
| Low | Low | Low | NC | ++ | |
| Low | Low | Low | NO | + | + |
| High | Low | Low | NC | + | + |
| High | Low | Low | NO | | ++ |
| — | Low | Low | NC | + | |
| — | Low | Low | NO | | + |
| Low | High | Low | NO | ++ | |
| High | High | Low | NC | ++ | |
| High | High | Low | NO | + | + |
| — | High | Low | NO | + | |
| Low | — | Low | NO | + | |
| High | — | Low | NC | + | |
| High | — | Low | NO | | + |
| Low | Low | High | NC | | ++ |
| Low | Low | High | NO | + | + |
| High | Low | High | NC | | ++ |
| — | Low | High | NC | | + |
| Low | High | High | NC | ++ | |
| Low | High | High | NO | + | + |
| High | High | High | NC | + | + |
| High | High | High | NO | | ++ |
| — | High | High | NC | + | |
| — | High | High | NO | | + |
| Low | — | High | NC | + | |
| Low | — | High | NO | | + |
| High | — | High | NC | | + |

Referring to FIGS. 31 to 33, it can be seen that a switch 1000 has been shown, consisting of a plurality of MEMS switches 1002, 1003, 1004 according to one or more of the embodiments described herein above.

The MEMS switches 1002, 1003 and 1004 of the switch 1000 are SOI switches, as described with reference to FIGS. 19 to 23, with a silicon substrate 1001, input/output lines 1008, 1009, 1010, 1011, switches 1002, 1003, 1004 made of electrically conductive material or alloys of materials, and a SiO₂ layer 1005 wherein cavities 1012, 1013, 1014 closed by the bases formed by the parts of the silicon layer 1006 on which rest the anchorings of the MEMS switches 1002, 1003 and 1004. A SiO₂ layer 1007 is interposed between the input/output lines 1008, 1009, 1010, 1011 and the layer 1006 and between the anchorings of the MEMS switches 1002, 1003 and 1004 and the layer 1006.

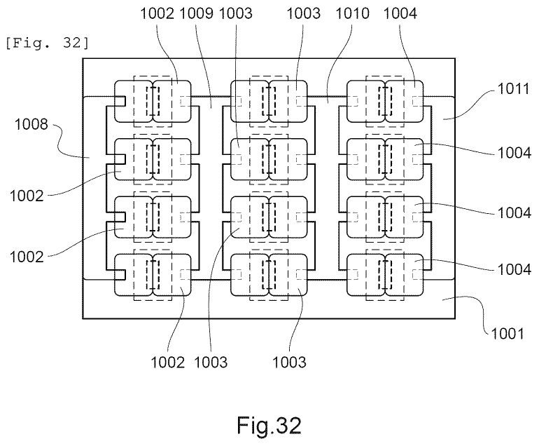

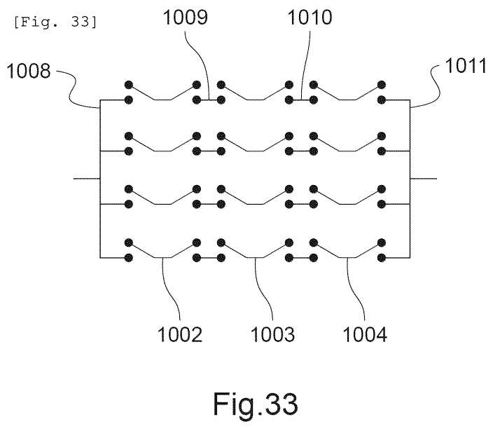

As can be seen in FIG. 32 and the equivalent circuit diagram in FIG. 33, the switch 1000 consists of a plurality of MEMS switches 1002, 1003, 1004 in series and in parallel, making it possible to withstand higher current and voltage levels than a single MEMS switch, and providing more significant switching possibilities.

The invention is obviously not limited to such architecture and any switch can be designed from a MEMS switch matrix according to any one or a plurality of the embodiments of the invention, in series and/or in parallel.

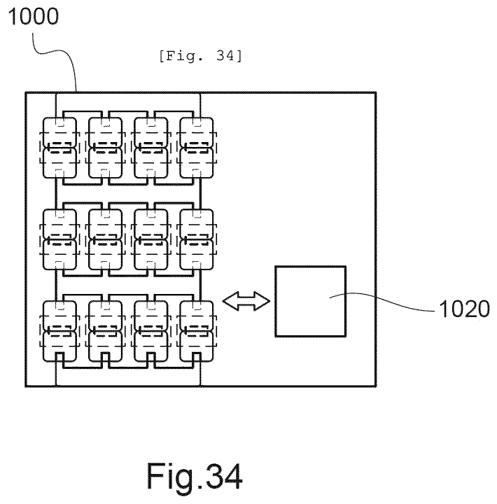

As shown in FIG. 34, the switch 1000 can be formed with an application specific integrated circuit (ASIC) 1020, which makes it possible to control the switching of each individual MEMS switch of the switch 1000 and can also serve as protection against electrostatic discharges (ESD), for DC/DC conversion, as a charge pump, as a protection during switching or else for the integration of sensors.

1-16. (canceled)

17. A micro-electromechanical system (MEMS) switch, comprising:
a substrate,
at least one signal input line,
at least one signal output line,
at least one contact zone formed on a contact zone base secured to the substrate, each contact zone being electrically connected to the at least one input line or the at least one output line,
a contact membrane held facing each contact zone by one amongst an anchoring formed on an anchoring base secured to the substrate and a plurality of anchoring on at least one anchoring base secured to the substrate,
the MEMS switch being configured to open or close an electrical path between the at least one input line and the at least one output line through at least one contact zone,
the switch being in the closed position when an electric current flows from at least one input line to at least one output line by contact of the contact membrane on at least one contact zone and in the open position when all the input lines are electrically isolated from all the output lines by an absence of contact of the contact membrane with all the contact zones,
wherein for each contact zone, the contact membrane forming a first entity, the contact base forming a second entity and the at least one anchoring base forming a third entity, at least two entities amongst the first entity, the second entity and the third entity are deformable, each by independent means of actuation, to move the contact membrane closer to or further away from the contact zone, to move the contact membrane from an initial open position to a closed position or from an initial closed position to an open position and to enhance at least one of the isolation in the open position and the contact force in the closed position.

18. The MEMS switch according to claim 17, wherein the contact membrane is connected to one of the at least one input line and the at least one output line.

19. The MEMS switch according to claim 17, wherein the contact membrane is isolated from the at least one input line and from the at least one output line in the open position.

20. The MEMS switch according to claim 17, wherein the at least one input line and the at least one output line are formed on the substrate.

21. The MEMS switch according to claim 17, wherein the at least one input line and the at least one output line are formed parallel to the substrate, on one of a secondary substrate bonded opposite the substrate and an anchoring secured to the substrate.

22. The MEMS switch according to claim 17, wherein each deformable base consists of a cavity membrane at least partially covering a hole formed in the substrate in order to form a cavity at least partially covered by the base.

23. The MEMS switch according to claim 22, wherein the substrate is of the silicon-on-insulator type, the cavity membrane being made of silicon, the cavity being formed between a first silicon layer formed by the substrate and a second silicon layer formed by the cavity membrane, the means for actuation the cavity membrane being configured to apply a difference of potential between the substrate and the cavity membrane for an electrostatic actuation of the cavity membrane, the applied difference of potential deforming the cavity membrane.

24. The MEMS switch according to claim 17, wherein each base consists of a cavity membrane supported by cavity membrane anchorings secured to the substrate so as to be suspended facing the substrate and to form an at least partially closed cavity between the substrate, the cavity membrane and the cavity membrane anchorings, the means of actuation of the cavity membrane being configured to apply a difference of potential between the cavity membrane and the surface of the substrate for electrostatic actuation of the cavity membrane, the applied difference of potential deforming the cavity membrane.

25. The MEMS switch according to claim 17, wherein the means of actuation of the contact membrane is configured to apply a difference of potential between the contact membrane and the surface below the contact membrane for electrostatic actuation of the contact membrane, the applied difference of potential deforming the contact membrane.

26. The MEMS switch according to claim 17, wherein the means of actuation of the contact membrane is an electrode arranged opposite the contact membrane.

27. The MEMS switch according to claim 17, wherein the contact membrane is encapsulated in an encapsulation space formed by one amongst wafer bonding and a thin film.

28. The MEMS switch according to claim 27, wherein the encapsulation space of the contact membrane contains one amongst a gas and a vacuum.

29. The MEMS switch according to claim 22, wherein each cavity is closed, and contains one amongst a gas and a vacuum.

30. The MEMS switch according to claim 17, wherein each anchoring of the contact membrane is formed at or in the vicinity of the maximum bending point of the anchoring base and each contact zone is formed at or in the vicinity of the maximum bending point of the contact zone base.

31. A switch comprising one or a plurality of MEMS switches according to claim 17 arranged with each other in one configuration amongst a configuration in parallel, a configuration in series and a configuration both in parallel and in series.

32. The switch according to claim 31, wherein the switch further comprises a control circuit integrated into the substrate.
